(19) United States
(12) Patent Application Publication
(10) Pub. No.: US 2025/0224873 A1
(43) Pub. Date: Jul. 10, 2025

(54) IDENTIFYING AND TRACKING HOST THREADS

(71) Applicant: Micron Technology, Inc., Boise, ID (US)

(72) Inventors: Roy Leonard, San Jose, CA (US); Xiangyu Tang, San Jose, CA (US)

(21) Appl. No.: 19/008,457

(22) Filed: Jan. 2, 2025

Related U.S. Application Data
(60) Provisional application No. 63/618,124, filed on Jan. 5, 2024.

(51) Int. Cl. G06F 3/06; G06F 12/0862

(52) U.S. Cl. CPC G06F 3/0611; G06F 3/0659; G06F 3/0679; G06F 12/0862

(57) ABSTRACT

A method includes identifying and tracking host threads. A read command is received including a first logical block address (LBA). The first LBA and a first stored LBA in a cache are determined to share a spatial locality. The first LBA and the first stored LBA share a spatial locality when the first LBA is within a predetermined number of LBAs from the first stored LBA. The first stored LBA is removed from the cache responsive to the determination that the first LBA and the first stored LBA share the spatial locality. The first LBA is then added to the cache.

### CROSS-REFERENCE TO RELATED APPLICATION

The present application claims the benefit of U.S. Provisional Patent Application No. 63/618,124 filed on Jan. 5, 2024, which is incorporated by reference herein in its entirety.

### TECHNICAL FIELD

The present disclosure generally relates to managing multiple host processes and, more specifically, relates to identifying and tracking host threads.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 illustrates an exemplary implementation of a thread tracker of a memory subsystem in accordance with some embodiments of the present disclosure.

FIG. 3 illustrates an example of a thread tracker mapping a new LBA to a previously identified thread in accordance with some embodiments of the present disclosure.

FIG. 4 illustrates an example of a thread tracker updating a previously identified thread in accordance with some embodiments of the present disclosure.

FIG. 5 illustrates an example of a thread tracker tracking a previously identified thread using a temporal locality tie breaker in accordance with some embodiments of the present disclosure.

FIG. 6 illustrates an example of a thread tracker tracking a previously identified thread using a behavioral locality tie breaker in accordance with some embodiments of the present disclosure.

FIGS. 7A-7B is a flow diagram of an example method to track threads in accordance with some embodiments of the present disclosure.

FIG. 8 is a flow diagram of an example method to identify and track host threads in accordance with some embodiments of the present disclosure.

FIG. 9 is a block diagram of an example computer system in which embodiments of the present disclosure may operate.

### DETAILED DESCRIPTION

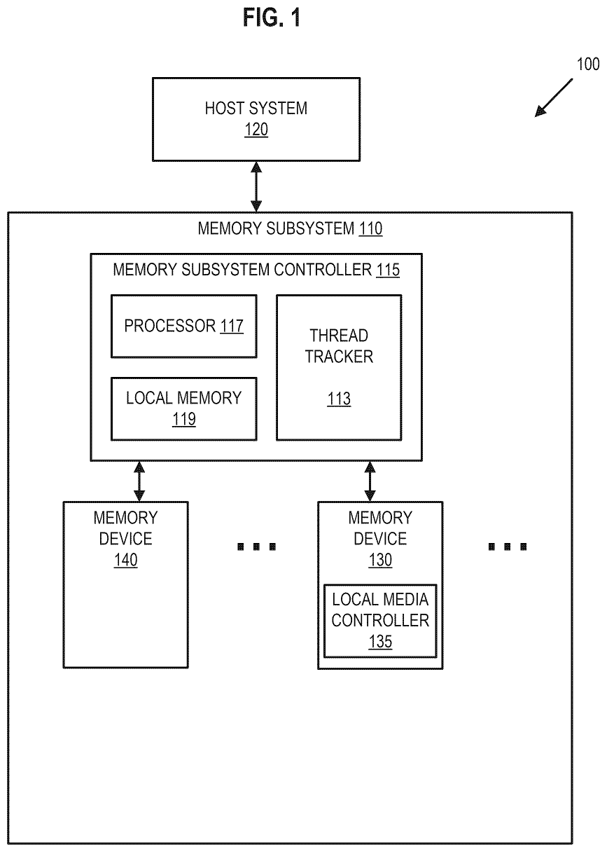

Aspects of the present disclosure are directed to identifying and tracking host threads in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), and quad-level cells (QLCs). For example, an SLC can store one bit of information and has two logic states.

A host system can execute multiple processes (referred to herein as threads) that each issue write commands or read commands to a memory subsystem, directing the memory subsystem to access locations/addresses in host memory. The accessed location/address in host memory can contain data to be written into the memory subsystem and/or read from the memory subsystem. For ease of description, the present disclosure is written from the perspective of the memory subsystem receiving a read command from the host system. For example, a thread of the host system issues a read command to the memory subsystem that directs the memory subsystem to a location in host memory addressed using a logical block address (LBA), where the read data is stored.

Each thread of the host system can issue a sequence of read commands, or an access pattern, that is unique to the particular thread of the host system. For example, a thread access pattern can include sequential logical addresses, logical addresses with a sequential stride, or random logical addresses. When the memory subsystem receives read commands from multiple threads, the access pattern of each thread is interleaved, obscuring the unique access pattern utilized by each thread. As a result, the memory subsystem processes the received read commands without leveraging the access pattern of each thread for performance or efficiency.

Aspects of the present disclosure address the above and other deficiencies by identifying thread access patterns in a sequence of interleaved read commands on the fly. For example, the memory subsystem identifies the thread issuing a read command in a received sequence of read commands based on access patterns of prior read commands. Tracking access patterns and a last requested LBA of threads allows the memory subsystem to identify unique access patterns in what would otherwise appear as a random sequence of read commands. The memory subsystem can use these access patterns to predict the next read command to be issued by the tracked thread. Predicting future read commands allows the memory subsystem to prefetch data, reducing read latency.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory device 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes thread tracker 113 that can identify and track thread read commands in an interleaved sequence of thread read commands. In some embodiments, the controller 115 includes at least a portion of the thread tracker 113. For example, the controller 115 can include a processor 117 (processing device) configured to execute instructions stored in local memory 119 for performing the operations described herein. In some embodiments, the thread tracker 113 is part of the host system 120, an application, or an operating system.

The thread tracker 113 determines whether an LBA of a received read command can be mapped to a tracked thread using a spatial locality, a behavior locality, and/or a temporal locality of the LBA of the received read command compared to the spatial locality, behavioral locality, and/or temporal locality of cached LBAs. The thread tracker 113 compares the LBA of a received read command to a spatial locality of the starting LBA of a recent read command issued by a particular thread or an ending LBA of a recent read command issued by the particular thread. If the spatial locality of the received LBA maps to the spatial locality of a cached LBA, the received LBA is added to the cache. In some instances, the received LBA is assigned a thread identifier that matches that of the cached read command. In other words, the thread tracker 113 identifies the received read command as being issued from a tracked thread. If the spatial locality of the received LBA maps to multiple spatial localities of cached LBAs, the thread tracker 113 uses a tiebreaker to determine how to assign a thread identifier to the received read command or the position in the cache to store the received LBA. The tiebreaker can include evaluating the temporal locality or spatial locality of each of the cached LBAs that that have a spatial locality mapped to that of the received read command. If the spatial locality of the received LBA does not map to the spatial locality of the cached LBAs, the thread tracker 113 adds the received LBA to a position in the cache associated with the most recent read command. Further details with regards to the operations of the thread tracker 113 are described below.

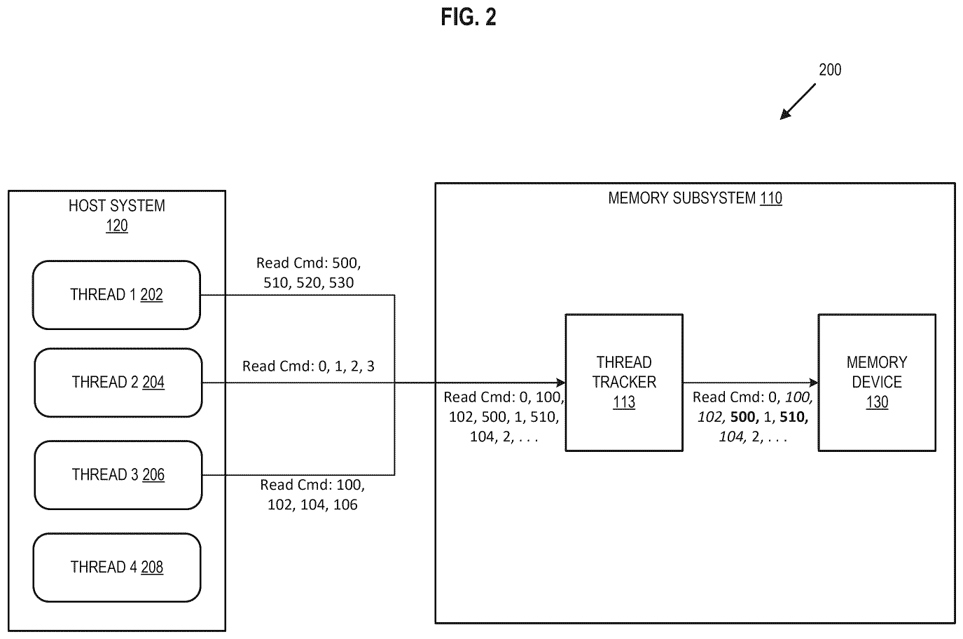

FIG. 2 illustrates an exemplary implementation of a thread tracker of a memory subsystem in accordance with some embodiments of the present disclosure. As shown in example 200, the thread tracker 113 receives read commands from thread 1 202, thread 2 204, and thread 3 206 from the host system 120. For example, each thread can represent a different process running within the host system 120. While read commands are shown, it should be appreciated that the thread tracker 113 can receive other commands from the host system 120 such as write commands.

Each of the read commands from the three host system 120 threads (e.g., thread 1 202, thread 2 204, and thread 3 206) are combined as a sequence of commands by the host system 120 such that they are received by the thread tracker 113 without an indication of the thread issuing the command and the read commands of each thread are interleaved. For example, the sequence of read commands received by the thread tracker 113 include a read starting at LBA0, a read starting at LBA100, a read starting at LBA102, a read starting at LBA500, a read starting at LBA1, a read starting at LBA510, a read starting at LBA104, and a read starting at LBA2.

While the read commands received by the thread tracker 113 appear random, the read commands issued by each of the threads of the host system 120 typically exhibit a spatial locality, a temporal locality, and a behavioral locality for that thread.

For example, threads request data according to a unique access pattern, where the access pattern describes the behavior of the thread (e.g., a behavioral locality). For instance, threads can include read commands with sequential addresses, threads can include read commands with addresses having a sequential stride/separation, etc. As shown in example 200, thread 1 202 issues read commands with a stride size of 10 (e.g., thread 1 202 issues a read command starting at LBA500, a read command starting at LBA510, a read command starting at LBA520, etc.), thread 2 204 issues read commands sequentially (e.g., thread 2 204 issues a read command starting at LBA0, a read command starting at LBA1, a read command starting at LBA2, etc.) and thread 3 204 issues read commands with a stride size of 2 (e.g., thread 3 206 issues a read command starting at LBA100, a read command starting at LBA102, a read command starting at LBA104, etc.)

Additionally, thread access patterns exhibit spatial locality based, in part, on restricted LBA access footprints defined by the host system 120. The host system 120 assigns each thread a unique range of LBAs that the thread can read/write to, preventing threads from accessing LBAs assigned to other threads (for security purposes, for instance). As shown in example 200, thread 1 202 issues read commands at LBAs in the 500 range, thread 2 204 issues read commands at LBAs in the tens range, and thread 3 206 issues read commands at LBAs in the 100 range. While read commands issued by a thread may appear to be random (e.g., not sequential or with an identifiable stride), those read commands can still exhibit spatial locality.

Additionally, thread access patterns exhibit a temporal locality. For example, threads issue read commands in bursts, where, during a first period, a thread does not issue read commands, during a second period, the thread issues multiple read commands, and during a third period of time, the thread does not issue read commands. As shown in example 200, thread 4 208 is not issuing read commands during the illustrated period.

The thread tracker 113 performs the processes described herein to map read commands to threads. Accordingly, the thread tracker 113 identifies access patterns that belong to a thread based on the behavioral locality, spatial locality, and/or temporal locality of the read command, and in particular, of the LBAs in the received read command as compared to stored LBAs. The output of the thread tracker 113 is a tagged read command, indicating a thread that issued the read command. The read command is tagged, for instance, using metadata that includes a thread identifier. In example 200, read commands assigned to the thread 2 204 identifier are visually tagged as belonging to thread 2 using plain text (e.g., LBA0, LBA1, and LBA2). Read commands assigned to the thread 1 202 identifier are visually tagged as belonging to thread 1 using bold text (e.g., LBA500, LBA510). Read commands assigned to the thread 3 206 identifier are visually tagged as belonging to thread 3 using italic text (e.g., LBA100, LBA102, LBA104). As a result, the access pattern of each thread is not obscured, and the memory device 130 can capitalize on the predictable behavior of each thread of the host system 120 by prefetching data, for instance.

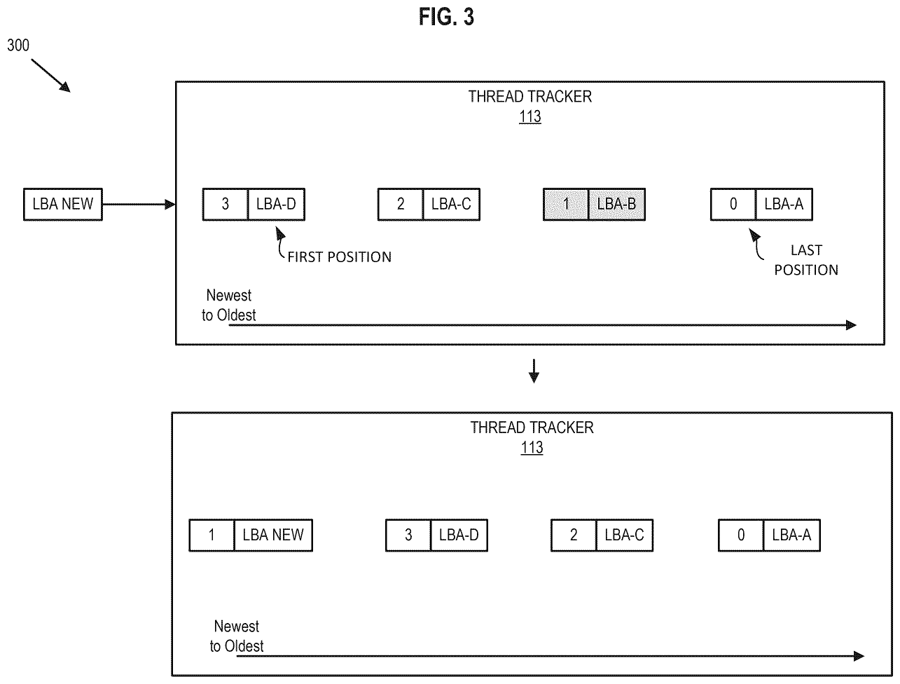

FIGS. 3-6 illustrate examples of a thread tracker assigning a thread identifier to a received read command, in accordance with some embodiments of the present disclosure. Specifically, FIG. 3 illustrates an example of a thread tracker mapping a new LBA to a previously identified thread in accordance with some embodiments of the present disclosure.

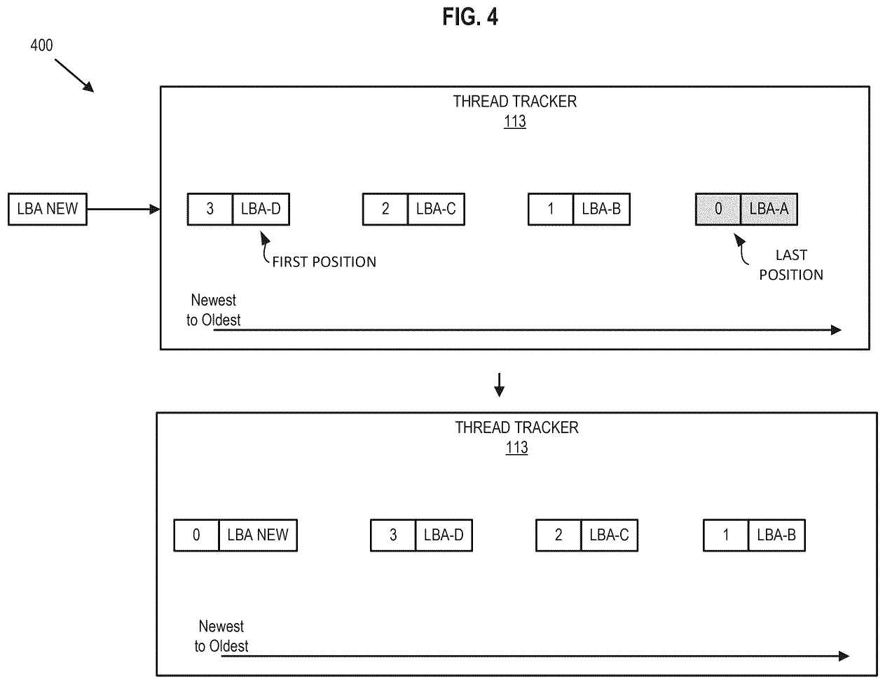

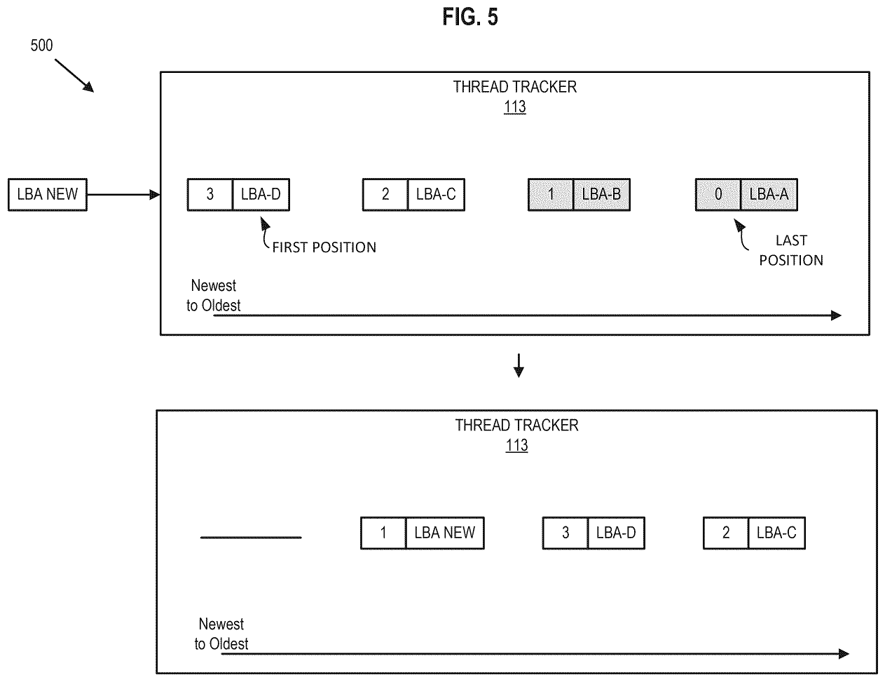

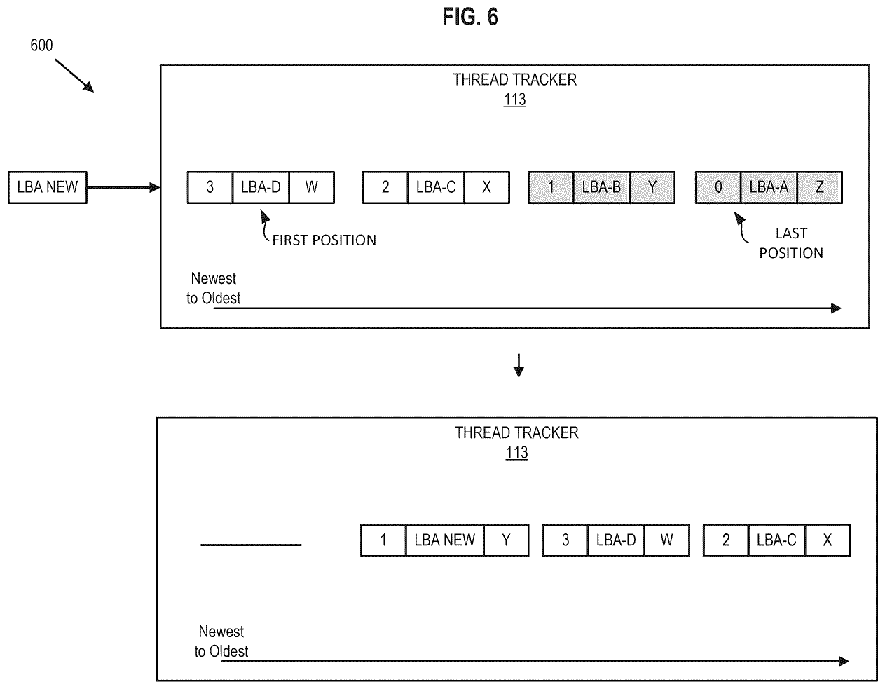

FIG. 4 illustrates an example of a thread tracker updating a previously identified thread in accordance with some embodiments of the present disclosure. FIG. 5 illustrates an example of a thread tracker tracking a previously identified thread using a temporal locality tie breaker in accordance with some embodiments of the present disclosure. FIG. 6 illustrates an example of a thread tracker tracking a previously identified thread using a behavioral locality tie breaker in accordance with some embodiments of the present disclosure.

In each of FIGS. 3-6, the illustrated examples assume that the thread tracker 113 maintains a data structure that can be implemented in hardware or software. In some embodiments, the data structure is a register implemented using hardware. In other embodiments, the data structure is a First-In-First-Out (FIFO) cache. For ease of description, the data structured maintained by the thread tracker 113 is described herein as a cache, where the positions of data stored in the cache represents a time the data was added to the cache. The size of the cache defines the number of threads that can be tracked. As shown in FIGS. 3-6, the thread tracker 113 can track four threads stored in four positions of the cache. Each of the tracked threads are assigned thread identifiers.

In some embodiments (e.g., FIGS. 3-5), the thread tracker 130 stores data in the cache as a pair of values. For example, the cache stores a thread identifier and a corresponding most recent LBA requested by a tracked thread. In other embodiments, each position of the cache identifies a tracked thread, and the cache stores the most recent LBA requested by a tracked thread. For example, position 0 in the cache identifies thread 0, position 1 in the cache identifies thread 1, etc. In other embodiments (e.g., FIG. 6), the thread tracker 130 stores data in the cache as a data tuple, as described further below.

The most recent LBA requested by the thread is the last LBA of the read command assigned to the thread. The LBA stored in the cache can be the first/starting LBA or the last LBA. For example, the last LBA of a read command including a starting LBA0 and a read size of 50 LBAs is LBA49.

As shown in examples 300-500, the initial state of tracked threads shows LBA-A as mapped to tracked thread 0, represented by thread identifier ‘0,’ LBA-B as mapped to tracked thread 1, represented by thread identifier ‘1,’ etc. As described herein, the position of the data stored in the cache represents a temporal sequence. For example, thread 3 represented by thread identifier ‘3’ is the most recent tracked thread in a first position of the FIFO cache, and thread 0 represented by thread identifier ‘0’ is the least recent (or oldest) tracked thread in the last position of the FIFO cache. In other words, LBA-D (mapped to thread 3) was cached later than LBA-A (mapped to thread 0).

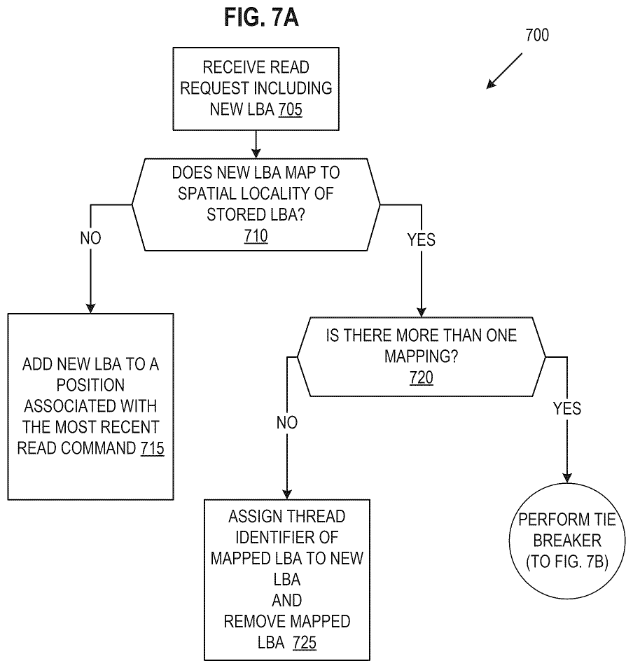

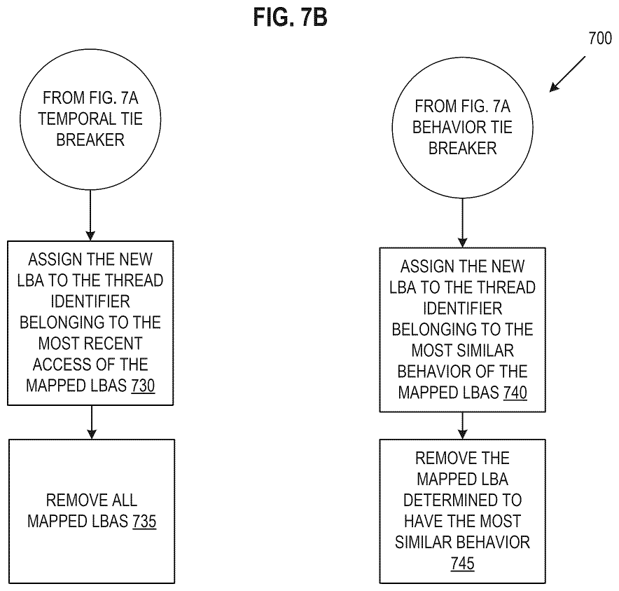

In example 300 of FIG. 3, a new LBA is received by the thread tracker 113, where the new LBA is a starting LBA of a read command. The thread tracker 113 evaluates the spatial locality of the new LBA by comparing the new LBA to each of the stored LBAs. Evaluating the spatial locality of the new LBA to each of the stored LBAs is described with reference to FIG. 7A-7B. Responsive to determining that the spatial locality of the new LBA maps to a spatial locality of a cached LBA (e.g., by comparing the most significant bits of the new LBA and each cached LBA, determining that the difference between the new LBA and a cached LBA satisfies a threshold, etc.), the thread tracker 113 updates the tracked thread represented by the thread identifier. As shown in example 300, the thread tracker 113 maps the new LBA to a spatial locality of LBA-B assigned to thread identifier ‘1.’ Accordingly, the thread tracker 113 assigns LBA new to thread identifier ‘1’ and stores LBA new in the first position of the FIFO cache. The thread tracker 113 evicts the LBA that mapped to the new LBA (e.g., LBA-B assigned to thread identifier ‘1’). When the thread tracker 113 evicts the LBA-B assigned to thread identifier ‘1’, the position of each of LBA-C assigned to thread identifier ‘2’ and LBA-D assigned to thread identifier ‘3’ shifts by one. As shown, the position of LBA-C assigned to thread identifier ‘2’ and LBA-D assigned to thread identifier ‘3’ move to an older position in the FIFO, as indicated by the right shift of each. The thread tracker 113 maintains temporal locality of the stored LBAs by assigning new LBAs to the first position in the FIFO cache and also shifting the position of the cached LBAs right in the FIFO cache. The use of temporal locality by the thread tracker 113 is discussed in greater detail below.

In example 400 of FIG. 4, a new LBA is received by the thread tracker 113, where the new LBA is a starting LBA of a read command. The thread tracker 113 evaluates the spatial locality of the new LBA by comparing the new LBA to each of the stored LBAs. Responsive to determining that the spatial locality of the new LBA does not map to a spatial locality of a cached LBA (e.g., by comparing the most significant bits of the new LBA and each cached LBA, determining that the difference between the new LBA and a cached LBA satisfies a threshold, etc.), the thread tracker 113 evicts the oldest cached LBA (e.g., the LBA stored in the last position of the FIFO cache) and assigns the thread identifier tagged to the oldest cached LBA to the new LBA (e.g., thread identifier ‘0’). The thread tracker 113 stores the new LBA with the assigned thread identifier at the first position in the FIFO cache and shifts each of the cached LBAs and assigned thread identifiers to an older position in the FIFO cache. In other words, each of the cached LBAs and assigned thread identifiers are shifted right.

In example 500 of FIG. 5, a new LBA is received by the thread tracker 113 where the new LBA is a starting LBA of a read command. The thread tracker 113 evaluates the spatial locality of the new LBA by comparing the new LBA to each of the stored LBAs. Responsive to determining that the spatial locality of the new LBA maps to multiple spatial localities of cached LBAs (e.g., by comparing the most significant bits of the new LBA and each cached LBA, determining that the difference between the new LBA and a cached LBA satisfies a threshold, etc.), the thread tracker 113 evaluates the temporal locality of the mapped cached LBAs.

In example 500, the thread tracker 113 maps the new LBA to the spatial locality of both LBA-A assigned to thread identifier ‘0’ and LBA-B assigned to thread identifier ‘1.’ The thread tracker 113 assigns the new LBA to the most recent tracked thread of thread identifier 0 and thread identifier 1, where the most recent tracked thread is cached at a newer position in the FIFO cache. As shown in example 500, LBA-B assigned to thread identifier ‘1’ was received more recently by virtue of being at a position in the FIFO cache before (e.g., to the left of) the position of LBA-A assigned to thread identifier ‘0.’ Accordingly, thread identifier ‘1’ assigned to LBA-B is updated and assigned to LBA new.

Both LBA-B assigned to thread identifier ‘1’ and LBA-A assigned to thread identifier ‘0’ are evicted from the cache in the illustrated example. In some embodiments, only the most recent cached LBA is evicted from the cache (e.g., LBA-B assigned to thread identifier ‘1’). As described herein, when the thread tracker 113 evicts cached LBAs and the assigned thread identifiers from the cache, each of the other stored LBAs and assigned thread identifiers are shifted to track the temporal locality of the cached LBAs. Accordingly, because two LBAs and assigned thread identifiers were evicted (e.g., LBA-A assigned to thread identifier ‘0’ and LBA-B assigned to thread identifier ‘1’) LBA-C assigned to thread identifier ‘2’ and LBA-D assigned to thread identifier ‘3’ are shifted by two positions to the right.

In example 600 of FIG. 6, the thread tracker 113 caches a data tuple in the FIFO cache including a thread identifier, a most recent LBA requested by the thread assigned to the thread identifier, and a behavior. The behavior indicates the access pattern of the thread identified using the thread identifier. For example, the behavior of the thread indicates that the thread is issuing read commands including sequential logical addresses, logical addresses with a sequential stride, or random logical addresses. As shown, the behavior of the thread identified by thread identifier ‘0’ is “Z,” the behavior of the thread identified by the thread identifier ‘1’ is “Y,” the behavior of the thread identified by the thread identifier ‘2’ is “X,” and the behavior of the thread identified by the thread identifier ‘3’ is “W.” Determining the behavior of each tracked thread is described with reference to FIGS. 7A-7B herein. The cached behavior can be a value (e.g., a stride size), a number of most recent LBA's issued by the identified thread, an expected next LBA to be issued by the thread, and the like.

In example 600, a new LBA is received by the thread tracker 113, where the new LBA is a starting LBA of a read command. The thread tracker 113 evaluates the spatial locality of the new LBA by comparing the new LBA to each of the stored LBAs. Responsive to determining that the spatial locality of the new LBA maps to multiple spatial localities of cached LBAs (e.g., by comparing the most significant bits of the new LBA and each cached LBA, determining that the difference between the new LBA and a cached LBA satisfies a threshold, etc.), the thread tracker 113 evaluates the behavioral locality of the mapped cached LBAs. Evaluating the behavioral locality of the new LBA and each of the mapped cached LBAs to determine the most similar cached LBA behavior is described with reference to FIG. 7A-7B. As shown, the thread tracker 113 determines that the thread identified by thread identifier ‘1’ has the most similar behavior to that of LBA new. Accordingly, the thread tracker 113 assigns the new LBA to thread identifier ‘1’ and the behavior ‘Y.’ The data tuple is stored in the cache. The thread tracker 113 evicts each of the mapped cached LBAs (e.g., LBA-B assigned to thread identifier ‘1’ and LBA-A assigned to thread identifier ‘0’) in the illustrated example. In some embodiments, the thread tracker 113 only evicts the cached LBA and corresponding thread identifier and behavior information of the most similar cached LBA behavior (e.g., LBA-B assigned to thread identifier ‘1’).

FIGS. 7A-7B is a flow diagram of an example method to track host threads in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the thread tracker 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 705, the processing device receives a read command including a starting LBA. For example, a thread of the host system issues a read command that directs the memory subsystem 110 to a location in host memory where the read data should be stored. The thread tracker 113 of the memory subsystem 110 receives the read command to assign a thread identifier to the read command using the LBA of the read command. For ease of description, the received starting LBA of the read command is referred to as the new LBA.

At operation 710, the processing device determines whether the new LBA maps to a spatial locality of a stored LBA. For example, the thread tracker 113 evaluates the spatial locality of the new LBA with respect to the spatial locality of cached LBAs. As described herein, the thread tracker 113 maintains a data structure (such as a FIFO cache). In some embodiments, the data structure stores the starting LBA of a recent read command issued by a particular thread or an ending LBA of a recent read command issued by the particular thread. In other embodiments, the data structure stores pairs of values, including a thread identifier and the starting LBA/ending LBA of the recent read command requested by a tracked thread. In yet other embodiments, the data structure stores tuples of data, including the thread identifier, the starting LBA/ending LBA of the recent read command requested by the tracked thread, and a behavior of the thread.

In some embodiments, to determine whether the new LBA maps to a spatial locality of a stored LBA, the thread tracker 113 compares the new LBA to a range of LBAs associated with each stored LBA. In operation, the thread tracker 113 determines whether the new LBA and a stored LBA are within a predetermined number of LBAs from each other. For example, the thread tracker 113 can determine whether the new LBA and the stored LBA are within a predetermined number of LBAs from each other by evaluating Expression (1) below:

$$( {LBA}_{x} - {LBA}_{New} - R ) ( {LPA}_{x} - {LBA}_{New} + R ) < 0 \qquad ( 1 )$$

In Expression (1) above, LBA_{New} is the LBA of the received read command, LBA_{X} represents the xth stored LBA in the cache, and R represents a predetermined range of LBAs, representing the spatial locality of each thread (e.g., a range of LBAs assigned to each thread by the host system). If Expression (1) is satisfied for the xth stored LBA (e.g., the value is less than 0), then the received LBA (e.g., LBA_{New}) is mapped to the spatial locality of the xth stored LBA. In operation, satisfying Expression (1) means that LBA_{New} is within the range of LBAs defined by R and starting at LBA_{X}. In other words, the difference between LBA_{New} and LBA_{X} satisfies a threshold (e.g., a predetermined number of LBAs R).

In other embodiments, to determine whether the new LBA maps to a spatial locality of a stored LBA, the thread tracker 113 compares the received LBA to a range of LBAs by comparing n number of most significant bits (MSBs) of the xth stored LBA in the cache (e.g., LBA_{X}) to the n number of MSBs of the received LBA (e.g., LBA_{New}). If n number of MSBs match, then the received LBA (e.g., LBA_{New}) is mapped to the spatial locality of spatial locality of the xth stored LBA.

If the thread tracker 113 determines that the new LBA satisfies a similar spatial locality to that of a stored LBA (e.g., the new LBA maps to a spatial locality of a stored LBA), the flow of operations moves to operation 720. If the thread tracker 113 determines that the new LBA does not map to the spatial locality of any stored LBAs, the flow of operations moves to operation 715.

At operation 715, adds the new LBA to the cache to a position associated with the most recent read command. For example, in examples 300-500 of FIGS. 3-5 described above, the thread tracker 113 adds the new LBA to the first/most recent position of the cache. If the cache is full, the processing device removes an oldest stored LBA of the cache and assigns the thread identifier of the oldest stored LBA to the new LBA. In operation, the thread tracker 113 updates a previously identified thread with a more recent LBA (e.g., LBA new) by assigning the thread identifier of the oldest stored LBA (e.g., the previously identified thread) to the new LBA. Updating a previously identified thread using the thread tracker 113 responsive to determining that the new LBA does not map to a spatial locality of a stored LBA is illustrated in FIG. 4.

When the thread tracker 113 removes the stored LBA, the thread tracker 113 overwrites the cached information (such as the thread identifier and the corresponding stored LBA) with adjacent cached information. Accordingly, the cached information is shifted in the FIFO cache, indicating the cached information is getting older. For example, as illustrated in FIG. 4, each of the cached LBAs and corresponding thread identifiers are shifted to the right and stored in an adjacent position in the FIFO cache.

At operation 720, the processing device determines whether more than one spatial locality of a stored LBA was mapped to the spatial locality of the new LBA. If more than one spatial locality of a stored LBA is mapped to the spatial locality of the new LBA, the flow of operations moves to FIG. 7B to determine which mapping to use. In operation 730 of FIG. 7B, a temporal tie breaker is used to map the new LBA to a stored LBA. Alternatively, in operation 740 of FIG. 7B, a behavioral tie breaker is used to map the new LBA to a stored LBA. If only one spatial locality of a stored LBA is mapped to the spatial locality of the new LBA, the flow of operations moves to operation 725. In some embodiments, the thread tracker 113 creates a subset of the stored LBAs that map to the spatial locality of the new LBA and uses a tie breaker, as described below, to select a mapping within the subset.

At operation 725, the processing device assigns the thread identifier of the stored LBA with the shared spatial locality (e.g., the mapped LBA) to that of the new LBA and removes the mapped LBA. Removing cached LBAs is described with reference to operation 715. The thread tracker 113 caches the new LBA with the assigned thread identifier at a most recent position in the FIFO cache (e.g., an available position in the cache associated with the most recent read command), updating a previously identified thread with a more recent LBA (e.g., LBA new). If the cache does not store thread identifiers, then the thread tracker caches the new LBA in the most recent position in the FIFO cache. Mapping a new LBA to a previously identified thread using the thread tracker 113 responsive to determining that the new LBA maps to a spatial locality of a stored LBA is illustrated in FIG. 3.

In some embodiments, operation 730 of FIG. 7B is performed in response to determining there is more than one spatial locality of a stored LBA that was mapped to the spatial locality of the new LBA. Operation 730 is a temporal tie breaker used to map the new LBA to a stored LBA of the multiple stored LBAs that share a spatial locality with the new LBA (e.g., the subset of cached LBAs). At operation 730, the processing device assigns the new LBA to the thread identifier belonging to the most recent access of the subset of LBAs. As described herein, the FIFO cache stores LBAs according to a temporal sequence, where LBAs stored in a first position are LBAs received at a point in time before other stored LBAs. LBAs stored in subsequent positions are older LBAs (e.g., LBAs received before the most recent received LBA).

When the thread tracker 113 assigns the new LBA to the thread identifier belonging to the most recent access of the subset of LBAs, the thread tracker 113 assigns the new LBA to the thread identifier belonging to the cached LBA of the subset of LBAs at a first position in the FIFO cache. If the cache does not store thread identifiers, then the thread tracker 113 caches the new LBA in the most recent position in the FIFO cache (e.g., at the first position in the FIFO cache).

At operation 735, the processing device evicts the subset of LBAS. For example, the thread tracker 113 evicts each of the multiple stored LBAs that map to the spatial locality of the new LBA. Tracking a previously identified thread using a temporal locality tie breaker of previously tracked threads is illustrated in FIG. 5.

In some embodiments, operation 740 of FIG. 7B is performed in response to determining there is more than one spatial locality of a stored LBA that was mapped to the spatial locality of the new LBA. Operation 740 is a behavioral tie breaker used to map the new LBA to a stored LBA of the multiple stored LBAs that share a spatial locality with the new LBA (e.g., the subset of cached LBAs). At operation 740, the processing device assigns the new LBA to the thread identifier belonging to the most similar behavior of the mapped LBAs.

The thread tracker 113 compares the behavior of each of the subset of LBAs to the new LBA to determine the most similar behavior of the mapped LBAs to the new LBA. The behavior is a representation of the access patterns of prior read commands issued by a thread. In some embodiments, the behavior is an exponential weighted average of a stride size of prior read commands issued by a thread. In other embodiments, the behavior is a windowed average of a stride size of prior read commands issued by the thread. In yet other embodiments, the behavior is a list of previously read LBAs and/or the last read LBA. In other embodiments, the behavior is an expected LBA determined by, for instance, combining the last read LBA with the exponential weighted average of the stride size or the windowed average of the stride size. In some embodiments, the thread tracker 113 adds the exponential weighted average of the stride size to the last read LBA (e.g., a stored LBA). In some embodiments, the thread tracker 113 updates the behavior of each thread after every read command (e.g., calculating a new exponential weighted average). In other embodiments, the thread tracker 113 updates the behavior of each thread identified using the thread identifier periodically.

In operation, a thread identified by thread identifier ‘0’ issues a first read command starting at LBA1 with an access size of 10. Accordingly, the last LBA read using the first read command is LBA10. The same thread, identified using thread identifier ‘0’ issues a second read command starting at LBA50 with an access size of 10. The thread tracker 113 can determine the behavior of the thread identified using thread identifier ‘0’ using the last LBA of the first read command and the first LBA of the second read command. The thread tracker 113 determines the stride size is LBA50−LBA10=40 LBAs. In other words, any new LBA requested by the thread identified using thread identifier ‘0’ is predicted to be 40 LBAs after the last read LBA. Given the example above, the last read LBA of the second read command is LBA60. In some embodiments, the thread tracker 113 stores the behavior of the thread identified using thread identifier ‘0’ as the expected LBA, which is LBA60+40 LBAs=LBA100. Accordingly, the behavior, stored in the cache, is LBA100 representing an expected LBA requested by the thread identified using thread identifier ‘0.’

The thread tracker 113 determines which thread identifier to assign to the new LBA using the expected LBA (e.g., the behavior) and the new LBA. For example, if the new LBA starts at LBA100, the thread tracker 113 assigns the new LBA to thread identifier ‘0’ because the new LBA (e.g., LBA100) is most similar to (e.g., matches) the behavior of the thread identified by thread identifier ‘0.’ In some embodiments, the thread tracker 113 determines a difference between the new LBA and each expected LBA (e.g., the behavior). For example, given an expected LBA104 mapped to thread identifier ‘0’ and expected LBA502 mapped to thread identifier ‘1,’ the thread tracker 113 determines that the difference between the expected LBA mapped to thread identifier ‘0’ is smaller than the difference between the expected LBA mapped to thread identifier ‘1.’ That is, the difference between LBA104 (e.g., mapped to thread identifier ‘0’) and LBA100 (e.g., the new LBA) is 4, which is smaller than the difference between and LBA502 (e.g., mapped to thread identifier ‘1’) and LBA100 (e.g., the new LBA), which is 402. In some embodiments, only the LBA determined to have the most similar behavior of the mapped LBAs is removed from the cache. For example, the thread identifier 113 evicts only the stored LBA with the behavior mapped to the new LBA. Removing cached LBAs is described with reference to operation 715.

In some embodiments, the processing device removes all the mapped LBAs that share similar spatial localities (e.g., the subset of LBAs) from the cache. Removing cached LBAs is described with reference to operation 715. Tracking a previously identified thread using a behavioral locality tie breaker of previously tracked threads is illustrated in FIG. 6.

In some embodiments, when a subsequent LBA is received (e.g., at operation 705), the thread tracker 113 assigns a new thread identifier to the subsequent LBA, as described above.

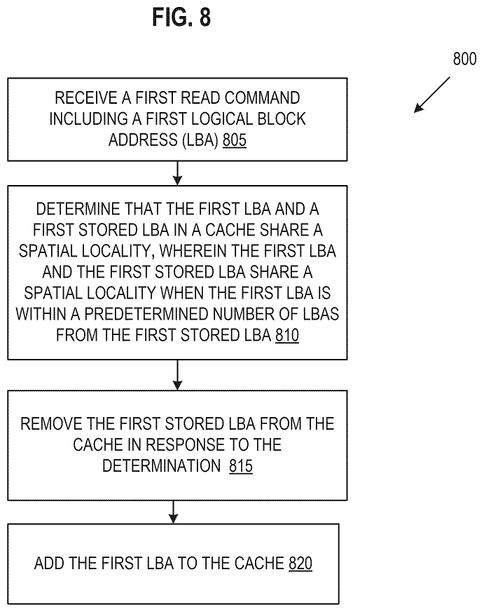

FIG. 8 is a flow diagram of an example method 800 to identify and track host threads in accordance with some embodiments of the present disclosure. The method 800 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 800 is performed by the thread tracker 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 805, the processing device receives a first read command including a first logical block address (LBA). As described with reference to operation 705 of FIG. 7A-7B, the thread tracker 113 receives a read command with a starting LBA.

At operation 810, the processing device determines that the first LBA and a stored LBA in a cache share a spatial locality. With reference to operations 710-725 of FIG. 7, the thread tracker 113 maintains a data structure such as a FIFO cache or a register implemented in hardware. The size of the cache defines the number of threads that can be tracked. In some embodiments, the cache stores pairs of values. For example, the cache stores the first/starting LBA or the last LBA of a read command and a corresponding thread identifier. In other embodiments, the cache stores a data tuple. For example, the cache stores the first/starting LBA or the last LBA of the read command, the thread identifier, and a behavior of the thread. In some embodiments, the behavior is an exponential weighted average of a stride size of the most recent read commands issued by the thread identified by the thread identifier, a windowed average of the stride size of the read commands issued by the thread identified by the thread identifier, a list of previously read LBAs, the LBA of the read command (e.g., the first/starting LBA or the last LBA of the read command), or an expected LBA determined, for instance, by combining the last LBA with the exponential weighted average of the stride size of the most recent read command issued by a tracked thread. When the thread tracker 113 determines that the first LBA and a first stored LBA share the spatial locality, the thread tracker 113 determines that the first LBA is within a predetermined number of LBAs from the first stored LBA. For example, the thread tracker 113 can compare the most significant bits of the new LBA and each cached LBA and/or determine that the difference between the new LBA and a cached LBA satisfies a threshold (e.g., a predetermined number of LBAs).

At operation 815, the processing device removes the stored LBA from the cache responsive to the determination of operation 810. If the first LBA maps to the spatial locality of a stored LBA, the first LBA is within a predetermined number of LBAs from the first stored LBA. Evicting stored LBAs is described with reference to 715.

At operation 820, the processing device adds the first LBA to the cache. The thread identifier 113 stores the first LBA at a position in the FIFO cache associated with the most recent read command. For example, the thread identifier 113 overwrites a stored LBA at the first position in the FIFO cache.

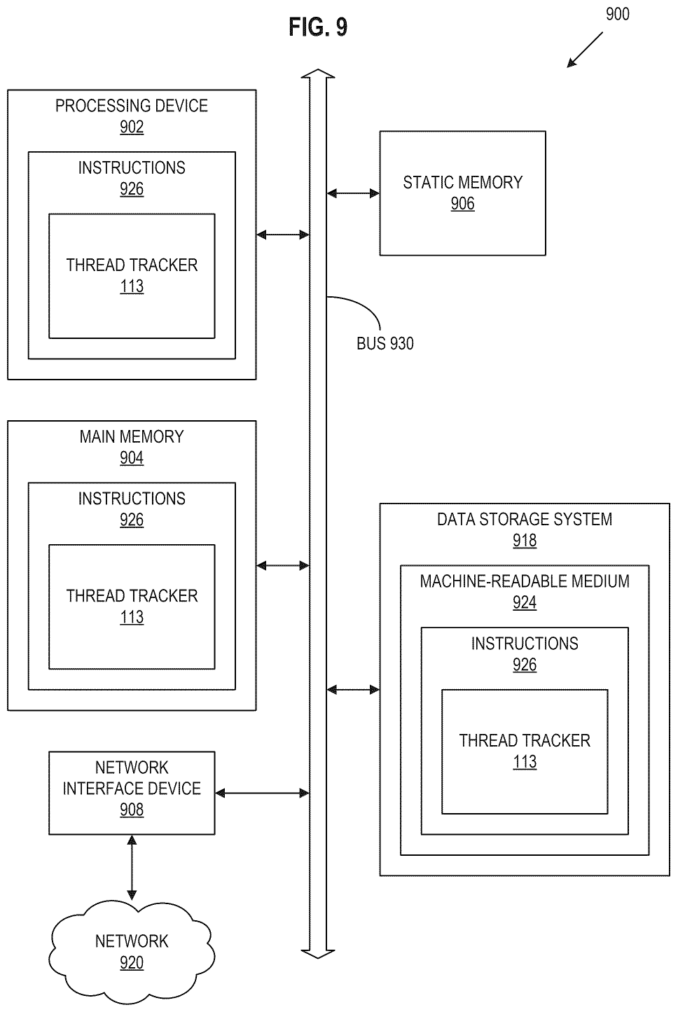

FIG. 9 illustrates an example machine of a computer system 900 within which a set of instructions, for causing the machine to perform any one or more of the methodologies discussed herein, can be executed. In some embodiments, the computer system 900 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the thread tracker 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage system 918, which communicate with each other via a bus 930.

Processing device 902 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein. The computer system 900 can further include a network interface device 908 to communicate over the network 920.

The data storage system 918 can include a machine-readable storage medium 924 (also known as a computer-readable medium) on which is stored one or more sets of instructions 926 or software embodying any one or more of the methodologies or functions described herein. The instructions 926 can also reside, completely or at least partially, within the main memory 904 and/or within the processing device 902 during execution thereof by the computer system 900, the main memory 904 and the processing device 902 also constituting machine-readable storage media. The machine-readable storage medium 924, data storage system 918, and/or main memory 904 can correspond to the memory subsystem 110 of FIG. 1.

In one embodiment, the instructions 926 include instructions to implement functionality corresponding to a thread tracker (e.g., the thread tracker 113 of FIG. 1). While the machine-readable storage medium 924 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the thread tracker 113, may carry out the computer-implemented method 700, in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a first read command including a first logical block address (LBA);
determining that the first LBA and a first stored LBA in a cache share a spatial locality, wherein the first LBA and the first stored LBA share a spatial locality when the first LBA is within a predetermined number of LBAs from the first stored LBA;
removing the first stored LBA from the cache in response to the determination; and
adding the first LBA to the cache.

2. The method of claim 1, wherein the cache is a first-in-first-out (FIFO) cache, the method further comprising:
receiving a second read command including a second LBA;
determining a difference between the second LBA and each stored LBA in the FIFO cache;
responsive to determining that the difference between the second LBA and each stored LBA in the FIFO cache does not satisfy a threshold, removing an oldest stored LBA in the FIFO cache; and
adding the second LBA to the FIFO cache.

3. The method of claim 2, the method further comprising:
assigning the second LBA to a thread identifier identifying the oldest stored LBA in the FIFO cache.

4. The method of claim 1, wherein the cache is a first-in-first-out (FIFO) cache, the method further comprising:
receiving a second read command including a second LBA;
determining a difference between the second LBA and each stored LBA in the FIFO cache;
responsive to determining that the difference between the second LBA and the first stored LBA in the FIFO cache satisfies a threshold range and the difference between the second LBA and a second stored LBA in the FIFO cache satisfies the threshold range, removing the first stored LBA from the FIFO cache and removing the second stored LBA from the FIFO cache; and
adding the second LBA to the cache.

5. The method of claim 1, wherein each stored LBA in the cache is paired with an access pattern.

6. The method of claim 5, further comprising:
receiving a read command including a second LBA;
determining that the second LBA and the first stored LBA in the cache share the spatial locality;
determining that the second LBA and a second stored LBA in the cache share the spatial locality; and
mapping the second LBA to the second stored LBA using a first thread access pattern.

7. The method of claim 6, wherein mapping the second LBA to the second stored LBA using the first thread access pattern further comprises:
determining the first thread access pattern by combining a weighted average of a plurality of stride sizes of a plurality of read commands to obtain an expected LBA issued by a first thread; and
matching the expected LBA to the second LBA.

8. A non-transitory computer-readable storage medium comprising instructions that, when executed by a processing device, cause the processing device to:
receive a first read command including a first logical block address (LBA);
determine that the first LBA and a first stored LBA in a cache share a spatial locality, wherein the first LBA and the first stored LBA share a spatial locality when the first LBA is within a predetermined number of LBAs from the first stored LBA;
remove the first stored LBA from the cache in response to the determination; and
add the first LBA to the cache.

9. The non-transitory computer-readable storage medium of claim 8, wherein the cache is a first-in-first-out (FIFO) cache, the processing device is further to:
receive a second read command including a second LBA;
determine a difference between the second LBA and each stored LBA in the FIFO cache;
responsive to determining that the difference between the second LBA and each stored LBA in the FIFO cache does not satisfy a threshold, removing an oldest stored LBA in the FIFO cache; and
add the second LBA to the FIFO cache.

10. The non-transitory computer-readable storage medium of claim 9, wherein the processing device is further to:
assign the second LBA to a thread identifier identifying the oldest stored LBA in the FIFO cache.

11. The non-transitory computer-readable storage medium of claim 8, wherein the cache is a first-in-first-out (FIFO) cache, the processing device is further to:
receive a second read command including a second LBA;
determine a difference between the second LBA and each stored LBA in the FIFO cache;
responsive to determining that the difference between the second LBA and the first stored LBA in the FIFO cache satisfies a threshold range and the difference between the second LBA and a second stored LBA in the FIFO cache satisfies the threshold range, removing the first stored LBA from the FIFO cache and removing the second stored LBA from the FIFO cache; and
add the second LBA to the cache.

12. The non-transitory computer-readable storage medium of claim 8, wherein each stored LBA in the cache is paired with an access pattern.

13. The non-transitory computer-readable storage medium of claim 12, wherein the processing device is further to:
receive a read command including a second LBA;
determine that the second LBA and the first stored LBA in the cache share the spatial locality;
determine that the second LBA and a second stored LBA in the cache share the spatial locality; and
map the second LBA to the second stored LBA using a first thread access pattern.

14. The non-transitory computer-readable storage medium of claim 13, wherein mapping the second LBA to the second stored LBA using the first thread access pattern further causes the processing device to:
determine the first thread access pattern by combining a weighted average of a plurality of stride sizes of a plurality of read commands to obtain an expected LBA issued by a first thread; and
match the expected LBA to the second LBA.

15. A system comprising:
a memory component; and
a processing device, operatively coupled with the memory component, to:
receive a first read command including a first logical block address (LBA);
determine that the first LBA and a first stored LBA in a cache share a spatial locality, wherein the first LBA and the first stored LBA share a spatial locality when the first LBA is within a predetermined number of LBAs from the first stored LBA, and wherein each stored LBA in the cache is paired with an access pattern;
remove the first stored LBA from the cache in response to the determination; and
add the first LBA to the cache.

16. The system of claim 15, wherein the cache is a first-in-first-out (FIFO) cache, the processing device is further to:
receive a second read command including a second LBA;
determine a difference between the second LBA and each stored LBA in the FIFO cache;
responsive to determining that the difference between the second LBA and each stored LBA in the FIFO cache does not satisfy a threshold, removing an oldest stored LBA in the FIFO cache; and
add the second LBA to the FIFO cache.

17. The system of claim 16, wherein the processing device is further to:
assign the second LBA to a thread identifier identifying the oldest stored LBA in the FIFO cache.

18. The system of claim 15, wherein the cache is a first-in-first-out (FIFO) cache, the processing device is further to:
receive a second read command including a second LBA;
determine a difference between the second LBA and each stored LBA in the FIFO cache;
responsive to determining that the difference between the second LBA and the first stored LBA in the FIFO cache satisfies a threshold range and the difference between the second LBA and a second stored LBA in the FIFO cache satisfies the threshold range, removing the first stored LBA from the FIFO cache and removing the second stored LBA from the FIFO cache; and
add the second LBA to the cache.

19. The system of claim 15, wherein the processing device is further to:
receive a read command including a second LBA;
determine that the second LBA and the first stored LBA in the cache share the spatial locality;
determine that the second LBA and a second stored LBA in the cache share the spatial locality; and
map the second LBA to the second stored LBA using a first thread access pattern.

20. The system of claim 19, wherein mapping the second LBA to the second stored LBA using the first thread access pattern further causes the processing device to:
determine the first thread access pattern by combining a weighted average of a plurality of stride sizes of a plurality of read commands to obtain an expected LBA issued by a first thread; and
match the expected LBA to the second LBA.
